(19) United States
(12) Patent Application Publication
(10) Pub. No.: US 2026/0268900 A1
(43) Pub. Date: Sep. 10, 2026

(54) METHOD, APPARATUS, DEVICE AND STORAGE MEDIUM FOR QUESTION ANSWERING

(71) Applicants: Beijing Youzhuju Network Technology Co., Ltd., Beijing (CN); Lemon Inc., Grand Cayman (KY)

(72) Inventors: Junwen PAN, Beijing (CN); Zhengsheng CAO, Beijing (CN); Qin GUAN, Beijing (CN); Shaobo GUO, Beijing (CN); Rui ZHANG, Beijing (CN); Xin WAN, Beijing (CN); Bo ZHANG, Beijing (CN); Kai HUANG, Beijing (CN)

(21) Appl. No.: 19/160,846

(22) PCT Filed: Mar. 12, 2024
(86) PCT No.: PCT/CN2024/081224

§ 371 Date: Aug. 28, 2025

(30) Foreign Application Priority Data
Mar. 13, 2023 (CN) 202310238535.1

(51) Int. Cl. G10L 15/22; G06F 40/30; G06V 10/40; G06V 10/70; G06V 10/98; G10L 15/18

(52) U.S. Cl. CPC G10L 15/22; G06F 40/30; G06V 10/40; G06V 10/70; G06V 10/993; G10L 15/1815

(57) ABSTRACT

Embodiments of the present disclosure provide a method, apparatus, device and storage medium for question answering. The method for question answering comprises: in response to detecting a question answering initiation, capturing image data and speech data using a device of a user, the speech data indicating an intent related to a question; determining an answer corresponding to the question from the image data according to the intent; and outputting the answer at least in form of speech.

This application claims the priority of Chinese Patent Application No. 2023102385351, filed on Mar. 13, 2023, entitled “Method, Apparatus, Device and Storage Medium for Question Answering”, the entirety of which is incorporated herein by reference.

### FIELD

Example embodiments of the present disclosure generally relate to the field of computer, and in particular, to a method, apparatus, device, and computer-readable storage medium for question answering.

### BACKGROUND

With the rapid development of information technology, increasingly more applications provide a question answering function, which brings many conveniences to users. Currently, applications (for example, a speech assistant) having a question answering function may output a corresponding answer based on a speech or a text input by a user. For example, the speech assistant may play a corresponding answer audio based on the user's speech question. However, it is also desirable to enable multimodal visual question answering (VAQ) conveniently and quickly in conjunction with visual information.

### SUMMARY

In a first aspect of the present disclosure, a method for question answering is provided. The method includes capturing image data and speech data using a device of a user in response to detecting a question answering initiation, the speech data indicating an intent related to a question; determining an answer corresponding to the question from the image data according to the intent; and outputting the answer at least in form of speech.

In a second aspect of the present disclosure, an apparatus for question answering is provided. The apparatus includes: a data capture module configured to capture image data and speech data using a device of a user in response to detecting a question answering initiation, the speech data indicating an intent related to a question; an answer determination module configured to determine an answer corresponding to the question from the image data according to the intent; and an answer output module configured to output the answer at least in form of speech.

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the electronic device to perform the method of the first aspect.

In a fourth aspect of the present disclosure, a computer-readable storage medium is provided. The medium stores a computer program thereon which, when executed by the processor, implements the method of the first aspect.

It should be understood that the content described in this section is not intended to limit essential features or important features of the embodiments of the present disclosure, nor is it intended to limit the scope of the present disclosure. Other features of the present disclosure will become easy to understand from the following description.

### BRIEF DESCRIPTION OF DRAWINGS

The above and other features, advantages, and aspects of various embodiments of the present disclosure will become more apparent from the following detailed description with reference to the accompanying drawings. In the drawings, the same or similar reference numerals refer to the same or similar elements, wherein:

FIG. 1 illustrates a schematic diagram of an example environment in which embodiments of the present disclosure can be implemented;

FIG. 2 illustrates a flowchart of a process for question answering according to some embodiments of the present disclosure;

FIG. 3 illustrates a schematic diagram of a recording interface according to some embodiments of the present disclosure;

FIG. 4 illustrates a schematic diagram of a question answering model according to some embodiments of the present disclosure;

FIG. 5 illustrates a schematic diagram of a flow of question answering according to some embodiments of the present disclosure;

FIG. 6 illustrates a schematic diagram of an interface for prompting description information according to some embodiments of the present disclosure;

FIG. 7 illustrates a schematic diagram of an interface for prompting a quality problem according to some embodiments of the present disclosure;

FIG. 8 illustrates a schematic diagram of routing of a question answering model according to some embodiments of the present disclosure;

FIG. 9 illustrates a block diagram of an apparatus for question answering according to some embodiments of the present disclosure; and

FIG. 10 illustrates a block diagram of a device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for example purposes only and are not intended to limit the scope of the present disclosure.

In the description of embodiments of the present disclosure, the term “include” and the like should be interpreted as an open term of “include”, i.e., “including but not limited to”. The term “based on” should be interpreted as “based at least in part on”. The term “one embodiment” or “the embodiment” should be interpreted as “at least one embodiment”. The term “some embodiments” should be interpreted as “at least some embodiments”. The term “first”, “second” or the like may refer to different or identical objects. Other explicit and implicit definitions may also be included below. As used herein, term “model” may represent an association relationship between various data. For example, the above association relationship may be obtained based on multiple technical solutions currently known and/or to be developed in the future.

Herein, unless explicitly stated, performing one step “in response to A” does not imply that this step is performed immediately after “A”, but may include one or more intermediate steps.

It may be understood that the data involved in the present technical solution (including but not limited to the data itself, acquisition or use of the data) should follow the requirements of the corresponding laws and regulations and related stipulations.

It should be understood that, before a technical solution disclosed in respective embodiments of the present disclosure is used, all of the types, the use scope, the use scenario and the like of personal information related to the present disclosure should be notified to the user in an appropriate manner and authorization of the user should be obtained according to the relevant laws and regulations.

For example, in response to receiving an active request from a user, prompt information is sent to the user to explicitly prompt the user that the requested operation will need to obtain and use personal information of the user. Therefore, the user can autonomously select whether to provide personal information to software or hardware, such as electronic device, application program, server, etc. executing an operation of a technical solution of the present disclosure according to the prompt information.

As an optional but non-limiting embodiment, in response to receiving an active request of the user, the prompt information may be sent to the user, for example, using a pop-up window, and the prompt information may be presented in text manner in the pop-up window. In addition, the pop-up window may further carry a target exploring control for the user to select “agree” or “disagree” to provide personal information to the electronic device.

It may be understood that the foregoing processes for notifying a user and obtaining authorization of the user are merely illustrative, and do not constitute a limitation on embodiments of the present disclosure, and other manners meeting related laws and regulations may also be applied to embodiments of the present disclosure.

As used herein, term “model” may learn an association relationship between respective inputs and outputs from training data such that a corresponding output may be generated for a given input after training is finished. Generation of the model may be based on machine learning techniques. Deep learning is a machine learning algorithm that processes inputs and provides corresponding outputs using a multi-layer processing unit. Neural network model is one example of a deep-learning-based model. As used herein, “model” may also be referred to as “machine learning model”, “learning model”, “machine learning network,” or “learning network,” which terms are used interchangeably herein.

“Neural network” is a deep-learning-based machine learning network. Neural network can process inputs and provide corresponding outputs, which typically include an input layer and an output layer and one or more hidden layers between the input layer and the output layer. Neural networks used in deep learning applications typically include many hidden layers, so as to increase the depth of the network. Each layer of the neural network is connected in sequence such that the output of a previous layer is provided as an input to its next layer, wherein the input layer receives an input of the neural network and an output of the output layer serves as a final output of the neural network. Each layer of the neural network includes one or more nodes (also referred to as processing node or neuron), and each node processes input from the previous layer.

Generally, machine learning may roughly include three phases, i.e., a training phase, a testing phase, and an applying phase (also referred to as an inferring phase). At the training stage, a given model may be trained using a large amount of training data, parameter values may be iteratively updated continually, until the model can obtain consistent inferences from the training data that satisfy the expected objective. By training, the model may be considered to be able to learn from the training data an association from input to output (also referred to as a mapping of input to output). The parameter values of the trained model are determined. In the testing phase, a test input is applied to the trained model and whether the model can provide a correct output is tested, thereby determining the performance of the model. In the applying stage, the model may be used to process an actual input based on the parameter values obtained by training to determine a corresponding output.

As mentioned briefly above, there are increasing applications that can provide question answering functions, which brings convenience to a vast number of users. Conventional applications with question answering functions (for example, a speech assistant) can only output corresponding answers based on speech or text input by a user. However, speech assistants are unable to visually provide assistance for users. For example, a conventional speech assistant can solve a general query irrelevant to vision, such as weather forecast, encyclopedia answer, home appliance control, and the like, but cannot address queries associated with vision, such as style, color, product brand, and the like of clothes.

Although some models with visual recognition functions are proposed, these models may be able to output recognition results associated with images (for example, identify types and names of plants included in images, identify commodity barcode information, etc.) for images, but cannot understand specific user intent in different scenarios. Such a model has passivity (the user cannot deliver intent to the application, can only passively receive a recognition result) and is not turned on (the application can only complete a predefined task, cannot cope with open-ended tasks in the open world, for example, cannot describe the style of clothes in detail).

Visual question answering (VQA) is a multi-modal understanding task, which requires answering a question in a certain language after understanding a visual content. Conventionally, the multi-modal visual question answering may be implemented manually, such as sharing a vision of a volunteer or related staff to the user through a video call (i.e., combining an image and user's question by human and making a corresponding answer to the user). However, the labor cost required for this solution is relatively high, work time of a volunteer cannot be guaranteed, and this solution is also limited by language.

Embodiments of the present disclosure provide an improved solution for question answering. According to the solution, image data and speech data indicating user intent are captured, and a corresponding answer is determined from the currently captured image data based on the intent, and then the answer is output at least in form of speech. In this way, an accurate answer corresponding to the user intent can be automatically and conveniently generated from the visual data, which improves accuracy and efficiency of obtaining information from the external environment through the electronic device by a user.

Moreover, the question answering solution provided by the present disclosure can effectively assist a user, especially people with persist or temporary visual loss or visual impairment, to realize multi-modal visual question answering. In some embodiments of the present disclosure, the solution can also prompt and help a user in completing accurate capturing of an object image, and can further provide more description information related to the object(s) to the user.

It should be understood that the solutions provided by embodiments of the present disclosure may provide convenience for a specific group of people, but this does not imply any discrimination to the specific group of people.

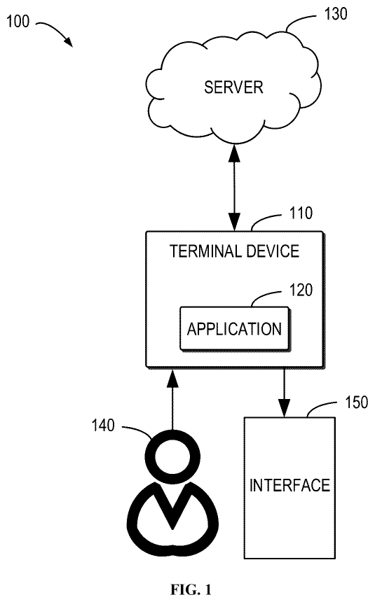

FIG. 1 illustrates a schematic diagram of an example environment 100 in which embodiments of the present disclosure can be implemented. In this example environment 100, an application 120 is installed in the terminal device 110. A user 140 may interact with the application 120 via the terminal device 110 and/or its attachment device. The application 120 is an application having at least a question answering function.

In some embodiments, the terminal device 110 communicates with a server 130 to enable provisioning of services to the application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a “wearable” circuit, etc.).

The terminal device 110 may include, for example, an appropriate type of sensor for detecting user gestures. For example, the terminal device 110 may include, for example, a touch screen for detecting various types of gestures made by the user on the touch screen. Alternatively, or in addition, the terminal device 110 may further include other suitable types of sensing devices such as proximity sensors, etc. to detect various types of gestures made by the user within a predetermined distance above the screen. For example, the terminal device 110 may further include a sound capturing device (for example, a microphone) for capturing user audio, a sound playing apparatus (for example, a speaker) for playing an audio, an image capturing device (for example, a camera and a camcorder, etc.) for capturing images, and a display screen (the display screen may be a touch screen) for interface display among others.

The server 130 may be a standalone physical server, or may be a distributed system or a server cluster composed of multiple physical servers, or may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms or the like. The server 130 may include, for example, a computing system/server, such as a mainframe, an edge computing node, a computing device in a cloud environment, or the like. The server 130 may provide a backstage service for the application 120 in the terminal device 110.

In some embodiments discussed below, a question answering function may be implemented by a plurality of models having various functions. One or more of these models may be deployed remotely in the server 130, the terminal device 110 may utilize the plurality of models to implement corresponding functions through communication with the server. Therefore, resources and power of the terminal device 110 may be saved, and computing efficiency may be improved using powerful resources of the server. In some embodiments, one or more of these models may also be deployed locally to the terminal device 110, which may be selected according to actual situations.

In some embodiments, in the environment 100 of FIG. 1, if the application 120 is active, the terminal device 110 may present an interface 150 of the application 120. Via the interface 150, the application 120 can provide one or more services related to a question answering function to the user 140, including capturing speech, capturing images, playing speech, displaying text, and the like.

It should be understood that the structure and function of the environment 100 is described for example purposes only and does not imply any limitation to the scope of the present disclosure.

Some example embodiments of the present disclosure will be described below with continued reference to the accompanying drawings.

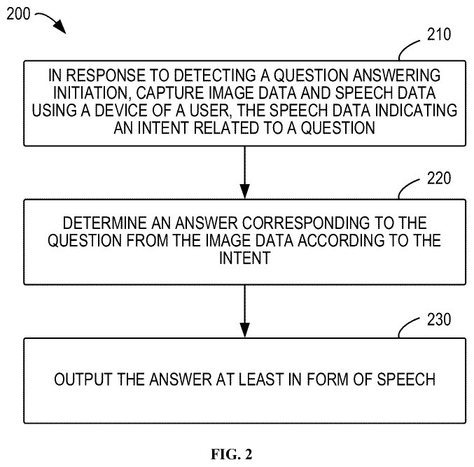

FIG. 2 illustrates a flowchart of a process 200 for question answering according to some embodiments of the present disclosure. The process 200 may be implemented at the terminal device 110. For ease of discussion, the process 200 will be described with reference to the environment 100 of FIG. 1.

At block 210, the terminal device 110 captures image data and speech data in response to detecting a question answering initiation, the speech data indicating an intent related to a question.

In some embodiments, the terminal device 110 may directly detect a question answering initiation initiated by the user. For example, in response to detecting a question answering initiation speech (for example, “turn on the question answering function”), the terminal device 110 may determine that a question answering initiation is detected. As another example, the terminal device 110 may detect a question answering initiation in response to detecting a preset operation on the hardware button (for example, a press operation, a long-press operation, etc.). In some embodiments, after detecting the question answering initiation, the terminal device 110 runs the application 120 having a question answering function, and captures image data and speech data.

In some embodiments, after the application 120 is started, the terminal device 110 presents a recording interface including at least a recording control through a display device. The terminal device 110 may detect a question answering initiation by detecting a predetermined operation on the recording control, that is, in response to detecting a predetermined operation on the recording control, the terminal device 110 may determine that a question answering initiation is detected, and then capture image data and speech data. The predetermined operation on the recording control may include, for example, a click operation, a slide operation, a long-press operation, and the like, which is not limited herein. In some embodiments, the predetermined operation on the recording control may also be initiated by speech or other instructions.

In some embodiments, in response to detecting a question answering initiation, the terminal device 110 may capture speech data indicating an intent related to a user's question through a sound capturing device, and capture image data through an image capturing device. The speech data may be of any language (e.g., Chinese, English, Japanese, etc.), any length of time (e.g., 3 s, 5 s, etc.), and any timbre. The image data may be of any form (still image, or video clip, etc.), any resolution, any format (e.g., PNG, JPG, etc.). Alternatively, or in addition, the image data may also be data stored in the terminal device 110 in advance.

In some embodiments, in the process of capturing image data and speech data, the terminal device 110 may further stop capturing image data and speech data in response to receiving a capture ending operation. Specifically, in response to detecting a speech such as “stop capturing data”, the terminal device 110 may determine that a capture ending operation is detected. In response to detecting a preset operation (for example, a press operation, a long-press operation, etc.) on a hardware button, the terminal device 110 may further determine that a capture ending operation is detected. In response to detecting another predetermined operation (e.g., a click operation, a release press operation, etc.) on a recording control in a recording interface, the terminal device 110 may further determine that a capture ending operation is detected.

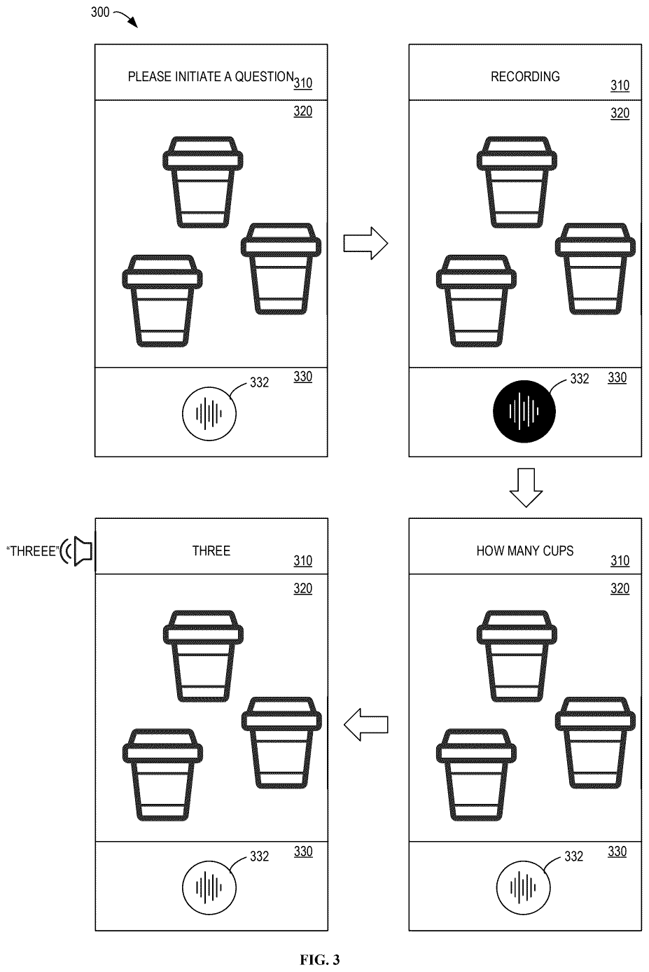

Refer to FIG. 3, which illustrates a schematic diagram of a recording interface 300 according to some embodiments of the present disclosure. The recording interface 300 may include a control display area 330 which at least presents a recording control 332. In response to detecting a predetermined operation on the recording control 332, the terminal device 110 may determine that a question answering initiation is detected. The terminal device 110 may further display text such as “recording” in a text prompt area 310 to prompt the user that the terminal device 110 is currently in a state of data capturing.

In some embodiments, in response to receiving a predetermined operation, the terminal device 110 indicates that the terminal device 110 is capturing speech data and image data by changing a presentation effect of the recording control 332 (for example, changing a color, a size, or the like of the recording control 332). Correspondingly, the terminal device 110 may stop capturing speech data and image data in response to receiving a capture ending operation. The terminal device 110 may switch the presentation effect of the recording control 332 back to a previous state in response to receiving the capture ending operation.

In some embodiments, the terminal device 110 may convert the captured speech data into text, and display the text in the text prompt area 310. As shown in FIG. 3, after capturing the speech data, the terminal device 110 displays text “how many cups” corresponding to the speech data at the text prompt area 310. At the same time, the terminal device 110 may present the image data currently captured by the terminal device 110 at the image display area 320. Speech-to-text conversion may be implemented by speech-to-text techniques, which may be performed locally to the terminal device 110 or by a remote server.

In some embodiments, in order to ensure the accuracy of the subsequently determined intent, the terminal device 110 may preprocess the captured speech data to eliminate noise (such as environmental sound) irrelevant to the question in the speech data.

Referring back to FIG. 2, at block 220, the terminal device 110 determines an answer corresponding to the question from the image data according to the intent indicated by the speech data.

In some embodiments, intent recognition may be performed on the captured speech data to determine an intent related to the question from the speech data. The terminal device 110 further identifies the image data based on the determined intent and obtain an answer corresponding to the intent.

Specifically, the terminal device 110 may identify the intent based on a dictionary and a rule method of the template. Different intents may have dictionaries of different domains, such as book names, song names, commodity names, and the like. The terminal device 110 may make a determination according to a matching degree or overlapping degree of the user's intent and the dictionary. The terminal device 110 may further determine the user intent based on a machine learning model. The terminal device 110 may perform training and learning on the annotated domain corpus through machine learning and deep learning methods and obtain an intent recognition model (for example, a model based on a fastText).

The terminal device 110 further identifies an intent indicated by the input language data based on the model.

Reference is made back to FIG. 3. After capturing speech data corresponding to “how many cups”, the terminal device 110 identifies the speech data, and determines that an intent corresponding to the question is to determine the number of cups in the image data. The terminal device 110 further identifies the image data based on the intent, and determines that the number of the cups included in the image data is 3, that is, the answer corresponding to the intent is “3”.

Reference is made back to FIG. 2. In some embodiments, the terminal device 110 may determine an answer corresponding to the question using the trained question answering model. Specifically, after the speech data is converted to a text sequence, the text sequence and the image data are input to the trained question answering model together, so that the question answering model outputs an answer corresponding to the intent indicated by the speech data.

In some embodiments, the question answering model includes at least four modules: an image encoder configured to encode image data into an image feature, a language encoder configured to encode a text sequence into a semantic feature, a fusion module configured to obtain an aggregated feature based on the image feature and the semantic feature, and a decoder configured to obtain a corresponding answer based on the aggregated feature. In some other embodiments, to simplify the structure of the model, the language encoder and the fusion module may be combined into a visual-language encoder, and the visual-language encoder is configured to encode the text sequence into a semantic feature, and generate an aggregated feature based on the semantic feature and the image feature code output by the image encoder.

In some embodiments, the plurality of encoders in the question answering model may be Transformer-based encoders, and the decoder in the question answering model may be a decoder adopting a similar structure as BERT, which may generate an answer based on a multimodal aggregated feature.

In some embodiments, the trained question answering model is deployed at the server 130, which may be a remote server (e.g., at a cloud end). The terminal device 110 may use the trained question answering model to implement a question answering function by communicating with the server 130. Specifically, the terminal device 110 may send the captured image data and speech data to the server 130, and the server 130 generates an answer based on the image data and the speech data using the trained question answering model. The terminal device 110 may obtain an answer from the server 130.

Alternatively, or in addition, in some other embodiments, the trained question answering model may also be deployed locally to the terminal device 110, and the terminal device 110 may directly use the trained question answering model deployed locally to generate an answer based on the captured image data and speech data.

In some embodiments, the terminal device 110 may convert speech data into a text sequence based on speech technology (for example, an automatic speech recognition (ASR) technology), and further provide image data and the text sequence to a question answering model in the server 130 or a local question-answering model.

The question answering model located at the server 130 or locally to the terminal device 110 may implement question answering generation based on visual technology and visual language multimodal technology. The vision techniques may include, for example, image quality control, optical character recognition (OCR), image detection, and the like. Visual language multimodal techniques may include, for example, visual question answering (VQA), visual description (Caption), visual language pre-training (VLP), and the like.

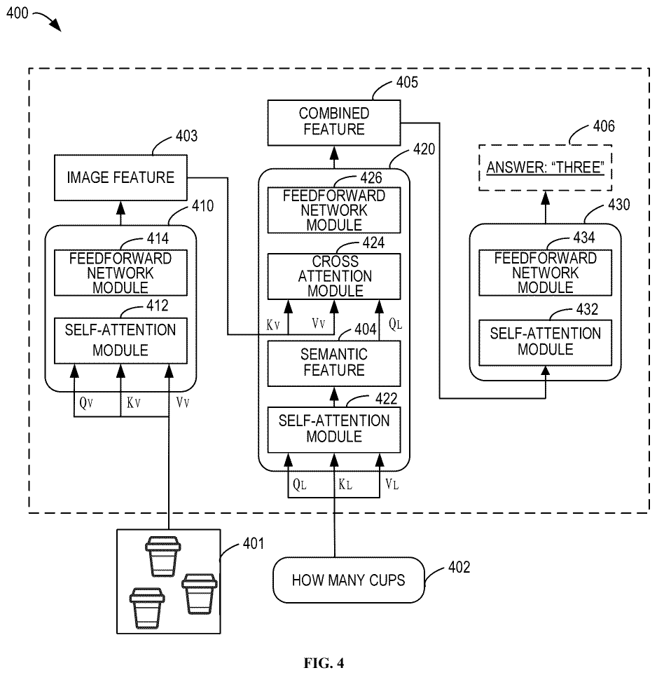

Refer to FIG. 4, which illustrates a schematic diagram of a question answering model 400 according to some embodiments of the present disclosure. The question answering model 400 may include a visual encoder 410, a visual-language encoder 420, and a decoder 430. The visual encoder 410 includes a self-attention module 412 and a feedforward network module 414. The visual-language encoder 420 includes a self-attention module 422, a cross attention module 424, and a feedforward network module 426. The decoder includes a self-attention module 432 and a feedforward network module 434.

In some implementations, the general processing of the attention module may be represented as follows:

$$Attention ( Q , K , V ) = soft max ( \frac{{QK}^{T}}{\sqrt{{d}_{k}}} ) V \qquad ( 1 )$$

where Q represents a query input, K represents a key input, V represents a value input, and dk represents the number of columns of Q and K, that is, a feature dimension. The above processing may be interpreted as calculating an attention weight matrix using the query input Q and the key input K, and determining a weighted sum on the value input V using the attention weight matrix.

In the question answering model 400, the terminal device 110 may use the image data 401 as a query input (Qv), a key input (Kv), and a value input (Vv) of the visual encoder 410. Then, the self-attention module 412 in the visual encoder 410 obtains an image feature 403 based on extraction from three inputs of Qv, Kv, and Vv.

The terminal device 110 may convert the speech data 402 into a text sequence and use the text sequence as a query input (QL), a key input (KL), and a value input (VL) of the visual-language encoder 420. The self-attention module 422 in the visual-language encoder 420 then obtains a semantic feature 404 based on extraction from three inputs of QL, KL, and VL. In some embodiments, to facilitate the cross attention module 424 to generate an aggregated feature 405 subsequently, the image feature 403 and the semantic feature 404 are features of the same dimension.

Further, the semantic feature 404 is provided as a query input (QL) of the cross attention module 424, and the image feature 403 is provided as a key input (Kv) and a value input (Vv) of the cross attention module 424. The cross attention module 424 may generate an aggregated feature 405 based on the three inputs of QL, Kv, and Vv.

The feedforward network module 414 in the visual encoder 410 and the feedforward network module 426 in the visual-language encoder 420 may have a function of spatially transforming the input data, may mine a nonlinear relationship of the features, and enhance the expressive ability of the features.

The aggregated feature 405 is provided to the decoder 430, and the self-attention module 432 in the decoder 430 may determine an answer 406 based on the aggregated feature 405. The feedforward network module 434 in the decoder 430 may have a function of spatially transforming the input data. In some embodiments, the feedforward network modules 414, 426, and 434 may each include a feedforward neural network (FFN) with one or more fully connected layers.

It should be understood that the question answering model 400 shown in FIG. 4 is merely an example, and should not constitute any limitation on the functions and structures of the question answering model described herein. There may be various variations in terms of the number and type of various modules in the encoder and decoder shown in FIG. 4. In some other embodiments, various other models capable of processing multi-modal data may also be adopted to generate an answer. Embodiments of the present disclosure are not limited thereto.

Continue to refer to FIG. 2. At block 230, the terminal device 110 outputs the answer at least in form of speech.

After obtaining the answer, the terminal device 110 may play the answer in form of speech through a sound display device. As shown in FIG. 3, the terminal device 110 may play the answer audio through a speaker. In some embodiments, the answer may be in text form. Text may be converted to speech by speech synthesis (TTS) for output. In this way, a user, especially a user with visual impairment, can be facilitated to quickly know the answer.

In some embodiments, alternatively, the terminal device 110 may further present the answer in a text form through a display screen. In some embodiments, the terminal device 110 may additionally output the answer in a vibration form and a visual form. The visual form may include, for example, an enlarged image, a highlighted image, or the like. For example, when speech data input by a user indicates inquiring the name of an object in image data, the terminal device 110 may enlarge the image data on the display screen to highlight the object when playing an answer audio including the name of the object.

In this way, an intent of the user's question can be determined based on speech data input by the user, the captured image data may be recognized based on the intent to generate an answer, and the answer may be output at least in form of speech, so that an answering interaction corresponding to the image data and the speech data can be conveniently and quickly realized, and accuracy and convenience of learning information in an external environment by the user can be improved.

Embodiments of a process for question answering are described above with reference to FIGS. 2-4. However, in some cases, image data captured by the terminal device 110 through an image capturing device cannot meet the requirement of question answering, that is, a correct answer cannot be generated based on such image data. In this case, the terminal device 110 may perform other operations.

Refer to FIG. 5, which illustrates a schematic diagram of a process 500 of question answering according to some embodiments of the present disclosure. The process 500 may be implemented at the terminal device 110. For ease of discussion, process 500 will be described with reference to the environment 100 of FIG. 1.

In some embodiments, in the process of capturing image data, a user, especially a visually impaired user, may not be able to accurately determine whether a device capturing area is aligned with an actual target, and thus may often need to search for a target and then initiate a question. Thus, at block 505 of the process 500, a target exploring stage prior to question is provided. At block 505, the user may be prompted with description information about the image data captured by the terminal device 110. The description information may roughly describe a content in a picture captured by the terminal device. In some embodiments, the description information includes at least one of the following: at least one object presented in the image data and a relative positional relationship between the objects. In this way, the user may adjust the attitude of the image capturing device based on the prompt to confirm that a target expected to be questioned can be captured.

In some embodiments, in the target exploring stage, a target exploring function may be achieved using a trained exploration model, of which, the input is image data, and the output is description information. Similar to a question answering model, the exploration model may be deployed at the server 130, and the terminal device 110 implements the target exploring function using the exploration model through communication with the server 130. The exploration model may also be deployed at the terminal device 110, and the terminal device 110 directly uses the model to implement the target exploring function.

In some embodiments, the captured image data may be identified and interpreted by the exploration model uninterruptedly at the target exploring stage, and description information corresponding to the image data is output.

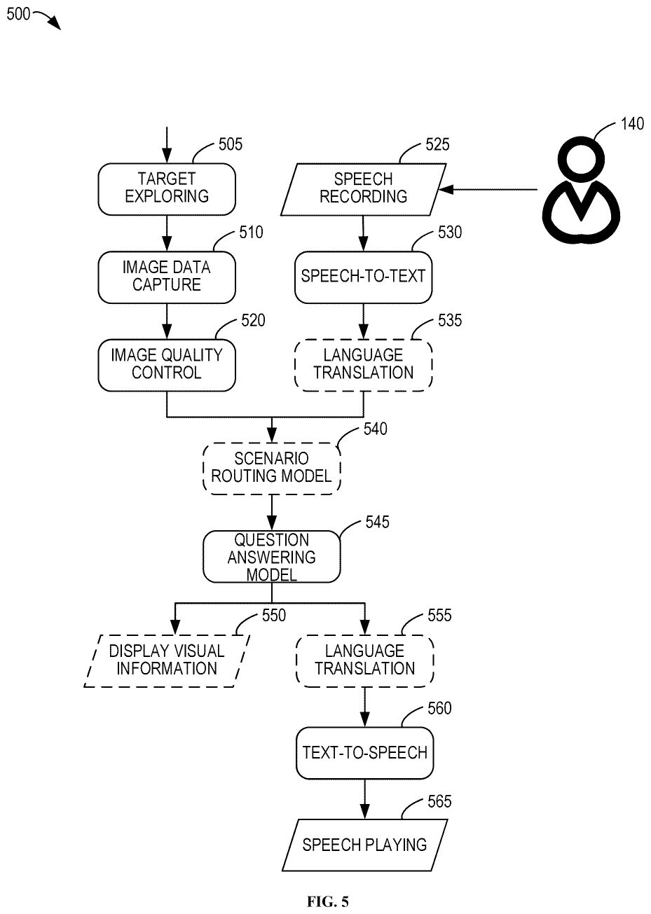

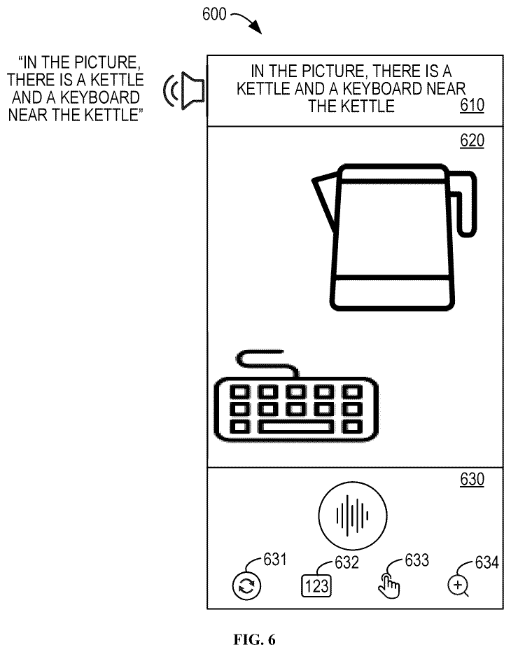

Refer to FIG. 6, which illustrates a schematic diagram of an interface 600 for prompting description information according to some embodiments of the present disclosure. The terminal device 110 may present the captured image data in the image display area 620. In some embodiments, in response to detecting a question answering initiation, target exploring may directly capture an external environmental image using the image capturing device in the terminal device 110, and prompt description information on the image data captured by the terminal device 110 to the user. In some embodiments, in response to receiving a predetermined operation (e.g., a click operation, a slide operation, a long-press operation, etc.) on an exploration control 634 in a control display area 630, it is determined that a target exploring operation is received, and description information on the image data captured by the terminal device 110 is prompted to the user. In some embodiments, an audio of the description information may be played using a sound playing apparatus. In some embodiments, the terminal device 110 may further display the description information in text form in a text prompt area 610 in the interface 600.

Therefore, the terminal device 110 may continuously provide description information for a user through the target exploring, and facilitate the user to confirm that the device can capture a target intended to be questioned to perform the next question answering dialogue. For example, in case the user cannot obtain visual information of an external environment, if the user wants to know relevant information of a kettle, the terminal device 110 may assist the user in obtaining the visual information of the external environment by providing continuous description information for the user, and prompt information on position and color of the kettle to the user in case image data of the kettle is captured. When the user wants to know information such as the brand and the capacity of the kettle, the user may send a corresponding speech to perform the next question answering dialogue.

The control display area 630 may further include a switch control 631 for switching a camera, a text recognition control 632 for indicating to recognize text in image data, and a target selection control 633 for selecting a target. In some embodiments, in response to receiving a predetermined operation (e.g., a click operation, a slide operation, a long-press operation, etc.) on the target selection control 633, the terminal device 110 may determine that a target selection mode is entered. In the target selection mode, in response to a user's touch operation on any object in image data, the terminal device 110 may prompt the description information on the object to the user. For example, in response to receiving a touch operation on an area where a kettle is located in the image display area 620, the terminal device 110 may prompt description information of the kettle to the user.

Reference is made back to FIG. 5. In some embodiments, after prompting the description information to the user, in response to a user operation (for example, the user triggers a question answering initiation or a capturing confirmation), the terminal device 110 captures image data 510 for subsequent initiation of a question answering. In addition, speech data of the user 140 may also be captured through speech recording 525.

In some embodiments, in order to ensure a visual quality of image data as much as possible to improve accuracy of a question answering, image data captured by the terminal device 110 through an image capturing device may be image data in video form. In this case, the terminal device 110 may capture image data in units of frames from a video to obtain an image dataset, and perform image quality control on the captured image dataset at block 520. Specifically, the terminal device 110 may detect a visual quality of each image data in the image dataset. The terminal device 110 may select, from the captured image dataset, image data with visual quality exceeding a quality threshold, and provide the image data to a trained question answering model 545 together with a text sequence obtained by converting the speech data through speech-to-text 530.

Regarding the specific manner of detecting visual quality, since a quality problem occurring most frequently in image data is a problem such as blurring, overexposure (too bright), underexposure (dark), improper framing (for example, incomplete object framing), occlusion, rotation etc., in some embodiments, the terminal device 110 may score image data in the captured image dataset for these problems. The higher the score, the better the visual quality of the image data; the lower the score, the worse the visual quality of the image data. In this way, by capturing a video and selecting image data with better visual quality therefrom, the terminal device 110 can reduce the problem of blurring caused by shaking and the like, which helps to improve the visual quality of image data, and further improve the accuracy of subsequent answering.

In some embodiments, in the image quality control stage, the terminal device 110 may further prompt the user to adjust a capturing environment to recapture image data in case a predetermined visual quality problem is determined to occur. In some embodiments, the predetermined visual quality problem includes at least an underexposure problem or an overexposure problem. In some embodiments, the predetermined visual quality problem may also include problems such as blurring, improper framing, occlusion, rotation etc. In some embodiments, the problem of blurring may be solved by selecting high-quality image data, while problems such as improper framing, occlusion, rotation etc. may further be solved by target exploring. In this way, it can be ensured that image data used by a user to initiate a question is of high quality and meets the requirement of the user's question.

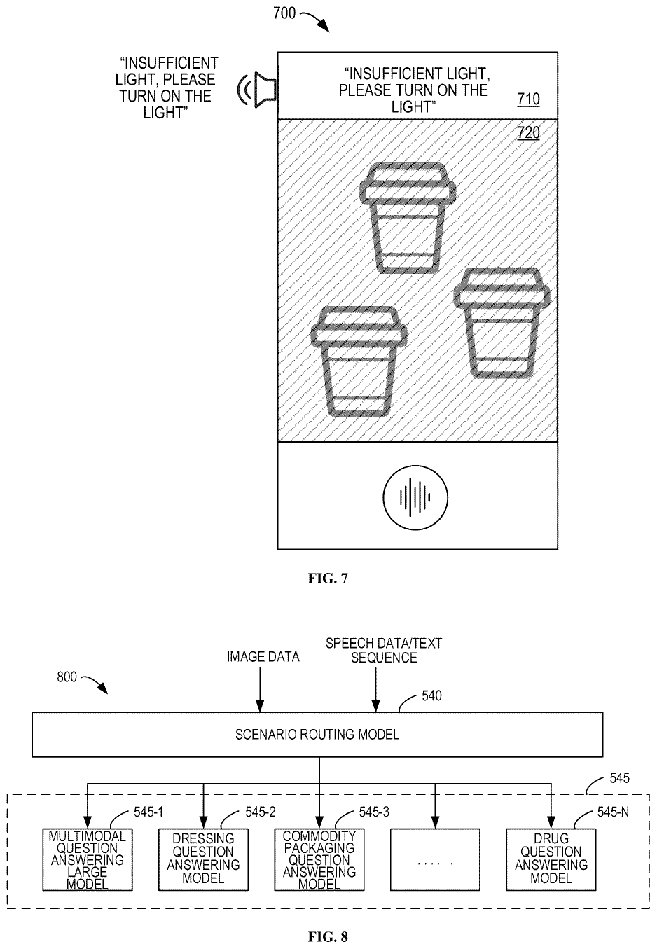

Refer to FIG. 7, which illustrates a schematic diagram of an interface 700 for prompting a quality problem according to some embodiments of the present disclosure. The terminal device 110 may present captured image data at the image display area 720. Whether a predetermined visual quality problem occurs in the captured image data may be determined at the image quality control stage. In accordance with a determination that there is an underexposure problem, an image quality control unit 520 may use the speaker to prompt the user that “insufficient light, please turn on the light” by playing a prompt audio.

In some embodiments, in the image quality control stage, the terminal device 110 may further display prompt text “insufficient light, please turn on the light” at a text prompt area 710.

In this way, the terminal device 110 instructs a user to recapture image data meeting the requirement on visual quality by prompting the user, which helps to improve visual quality of image data, and further improves accuracy of subsequent answering.

Reference is made back to FIG. 5. In some embodiments, if the predetermined visual quality problem is a rotation problem, the terminal device 110 may change an image angle through an image processing algorithm, to correct the rotated image, and then provide a trained question answering model with the corrected image data together with a text sequence obtained by converting speech data through speech-to-text 530.

In some embodiments, in the image quality control stage, the terminal device 110 may use a trained quality detecting and processing model to detect the visual quality of an image data and process the image data correspondingly. Similarly, the quality detecting and processing model may be deployed at the server 130, or may be deployed locally to the terminal device 110.

In some embodiments, speech data input by a user 140 may not be of a default language type of a question answering model (for example, the default language type is Chinese, and the language type corresponding to the speech data input by the user is English). In this case, the terminal device 110 may further perform a language translation 555 which converts a text sequence to a text sequence of the default language type of the model, and perform a language translation 555 again which translates an answer output by the model into the language type corresponding to the user input language.

In some embodiments, question answering models in different application scenarios may be the same, and image data and a text sequence may be directly provided to a question answering model. In other embodiments, different question answering models may be preselected and trained for different application scenarios. In this way, each question answering model can give answers which are more accurate and better meet user's expectation for respective application scenarios. In such implementations, image data and a text sequence may firstly be provided to a scenario routing model 540, which determines an application scenario based thereupon and provides the image data and the text sequence to a question answering model 545 corresponding to the determined application scenario.

Refer to FIG. 8, which illustrates a schematic diagram of routing of a question answering model according to some embodiments of the present disclosure. The scenario routing model 540 may determine a plurality of question answering models 545 corresponding to a plurality of question answering scenarios. After obtaining image data and a text sequence, the scenario routing model 540 determines a question answering scenario (that is, an application scenario) corresponding to the image data and the text sequence. For example, in case the image data includes an image of clothes, and the text sequence includes a text sequence corresponding to “what's the pattern of the clothes”, the scenario routing model 540 determines that a corresponding question answering scenario is a dressing scenario, and provides the image data and the text sequence to a dressing problem model 545-2 corresponding to the dressing scenario.

In some embodiments, in case there is no image data and text sequence corresponding to the question answering scenario, that is, the scenario routing model 540 cannot determine a question answering scenario corresponding to them, the scenario routing model 540 may provide them to a general multimodal question answering large model 545-1. The general multimodal question answering large model 545-1 is a question answering model applied to a general scenario.

In some embodiments, the model structures of different question answering models 545 corresponding to different scenarios are the same, and the difference between the plurality of question answering models is training data. That is, a question answering model 545 obtained by training image data and speech data associated with clothes question answering is a dressing question answering model 545-2 corresponding to the dressing scenario, and a question answering model obtained by training image data and speech data related to commodity is a commodity packaging question answering model 545-3 corresponding to a commodity packaging scenario. The general multimodal question answering large model 545-1 may be a question answering model obtained using training data corresponding to a plurality of scenarios for training.

In some embodiments, training data used to train a question answering model 545 may be data obtained by the terminal device 110 or the server 130 from different scenarios. For example, training data used to train the general multimodal large question answering model 545-1 may be network image-text pair data, network Chinese data, general visual question answering data, and the like associated with general life scenarios. Training data used to train specific scenarios such as a dressing scenario, a commodity packaging scenario, a drug question answering scenario etc. may be data of e-commerce, live broadcast sales, commodity information data, and health knowledge graph associated with these scenarios. In addition, training data of a question answering model corresponding to a visual impairment life scenario for a visual impairment user may be visual impairment vision question answering data and private data obtained with the user's authorization.

In this way, a general question answering model can be used to solve most question answering problems, and in some specific scenarios, a more accurate answer is generated using the specific question answering model corresponding to a specific scenario, which can be guarantee accuracy of answers in different scenarios. In addition, automatic selection of a question answering model is realized based on scenario using a scenario routing model, so that as a scenario is switched, the question answering model can be flexibly switched, and the switching process is automatic and cannot be perceived by a user, which can improve efficiency and accuracy of question answering.

Reference is made back to FIG. 5. In some embodiments, the scenario routing model 540 may also be deployed at the server 130, and the terminal device 110 may determine a question-answer scenario and select a corresponding question-answer model using the scenario routing model 540 through communication with the server 130. In some other embodiments, the scenario routing model 540 may also be deployed locally to the terminal device 110, and the terminal device 110 may directly use the scenario routing model to determine a question answering scenario and select a corresponding question answering model.

In some embodiments, the selected question answering model 545 may obtain a corresponding answer based on image data and a text sequence. The terminal device 110 may display visual information 550 based on an answer, for example, present the answer on a display screen in text form. The terminal device 110 may further convert the answer into audio through text-to-speech (for example, TTS technology) at block 560, and then perform speech playing 565 using a sound display device, to play an audio corresponding to the answer.

An example process of question answering is described above with reference to FIGS. 2-8. Such a question answering solution may be applied to multiple question answering scenarios, and provide convenience for users in the multiple question answering scenarios. The multiple question answering scenarios may include, for example, barrier-free offline shopping, barrier-free home life, barrier-free live shopping, and the like.

For example, in a barrier-free offline shopping scenario, the terminal device 110 may provide with convenience for offline shopping of users, improve their shopping experience, and greatly reduce various uncertainties in offline shopping scenarios. Specifically, when clothing is selected and purchased, the terminal device 110 may help users easily obtain visual information such as style, color, size, price, or the like of clothes, so that the user may select and try on clothes more freely. When collecting and purchasing food in a supermarket, the user may ask questions such as taste, weight, shelf life or the like.

The shopping experience can be completed independently, without other's help and not having to listen to the speech of a large section of irrelevant content of the auxiliary tools.

For example, in a barrier-free home life scenario, the terminal device 110 may flexibly support an open-ended task and an open scenario through a speech dialog, and assist daily life of users in a most natural manner. For example, the terminal device 110 using the question answering scheme described in the present solution can easily cope with common challenges such as “sock color matching”, “whether clothes need cleaning”, etc. The terminal device 110 may help a user quickly find essential information such as food name, shelf life, the heat contained from detailed information of a commodity, and the terminal device 110 may also help a user obtain information such as ingredients, specifications, usage and dosage or the like of a drug from package inserts of the drug.

For example, in a barrier-free live shopping scenario, the terminal device 110 using the question answering scheme described in the present solution may provide a visual capability. The terminal device 110 may initiate a dialogue at any interface through a system basic capability such as a shortcut instruction etc., helping the user understand a visual content presented on a display screen. For example, the user may learn basic information such as style, color or the like of clothes through the terminal device 110; when browsing a multimedia content, the user may ask the terminal device 110 so as to learn the content of accompanying picture.

It should be understood that the above question answering scenario is merely an example, and should not constitute any limitation on the application scope of the embodiments described herein.

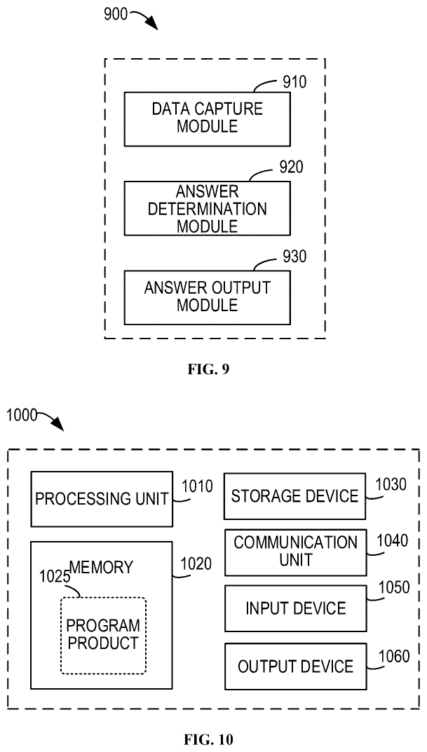

FIG. 9 illustrates a block diagram of an apparatus 900 for question answering according to some embodiments of the present disclosure. The apparatus 900 may, for example, be implemented as or included in the terminal device 110. The various modules/components in the apparatus 900 may be implemented in hardware, software, firmware, or any combination thereof.

As shown, the apparatus 900 includes a data capture module 910 configured to capture image data and speech data using a device of a user in response to detecting a question answering initiation, the speech data indicating an intent related to a question. The apparatus 900 further includes an answer determination module 920 configured to determine an answer corresponding to the question from the image data according to the intent. The apparatus 900 further includes an answer output module 930 configured to output the answer at least in form of speech.

In some embodiments, the apparatus 900 further includes: an interface presentation module configured to present a recording interface, the recording interface including at least a recording control; and an operation detection module configured to detect a question answering initiation by detecting a predetermined operation on the recording control.

In some embodiments, the data capture module 910 is further configured to select image data with a visual quality exceeding a quality threshold from the captured image dataset.

In some embodiments, the data capture module 910 includes: a quality determination module configured to determine whether a predetermined visual quality problem occurs in the captured image data; and a prompt module configured to prompt the user to adjust a capturing environment to recapture image data in accordance with a determination that the predetermined visual quality problem occurs.

In some embodiments, the predetermined visual quality problem includes at least an underexposure problem or an overexposure problem.

In some embodiments, the data capture module 910 includes: a description information prompt module configured to prompt to the user description information on the image data captured by the device during the capturing; and an image data capture module configured to obtain image data captured by the device in response to detecting a capturing confirmation.

In some embodiments, the description information indicates at least one of the following: at least one object presented in the image data, or a relative positional relationship between the at least one object.

In some embodiments, the description information prompt module is further configured to prompt description information in response to detecting a target exploring operation.

In some embodiments, the answer is determined using a trained question answering model, and the model input of the question answering model includes the image data and a text sequence corresponding to the speech data.

In some embodiments, the question answering model includes at least a cross attention module and determines an answer by: extracting an image feature of the image data; extracting a semantic feature of a text sequence; generating an aggregated feature by providing the semantic feature as a query input of the cross attention module and providing the image feature as a key input and a value input of the cross attention module; and determining the answer based on the aggregated feature.

In some embodiments, the question answering model corresponds to a first question answering scenario of a plurality of question answering scenarios, and the question answering model is selected based on the image data and the speech data being classified into the first question answering scenario.

FIG. 10 illustrates a block diagram of an electronic device 1000 in which one or more embodiments of the present disclosure may be implemented. It should be understood that the electronic device 1000 illustrated in FIG. 10 is merely an example and should not constitute any limitation on the function and scope of the embodiments described herein. The electronic device 1000 illustrated in FIG. 10 may be configured to implement the terminal device 110 and/or the server 130 in FIG. 1.

As shown in FIG. 10, the electronic device 1000 is in the form of a general-purpose electronic device. Components of the electronic device 1000 may include, but are not limited to, one or more processors or processing units 1010, a memory 1020, a storage device 1030, one or more communication units 1040, one or more input devices 1050, and one or more output devices 1060. The processing unit 1010 may be an actual or virtual processor and capable of performing various processes according to programs stored in the memory 1020. In a multi-processor system, multiple processing units execute computer-executable instructions in parallel to improve parallel processing capability of electronic device 1000.

The electronic device 1000 typically includes a plurality of computer storage mediums. Such mediums may be any available medium accessible to the electronic device 1000, including, but is not limited to, volatile and non-volatile medium, removable and non-removable medium. The memory 1020 may be a volatile memory (e.g., register, cache, random access memory (RAM)), a non-volatile memory (e.g., read-only memory (ROM), electrically erasable programmable read-only memory (EEPROM), flash memory), or some combination thereof. The storage device 1030 may be a removable or non-removable medium and may include a machine-readable medium, such as flash drive, magnetic disk, or any other medium which may be capable of storing information and/or data (e.g., training data for training) and may be accessed within the electronic device 1000.

The electronic device 1000 may further include additional removable/non-removable, volatile/non-volatile storage medium. Although not shown in FIG. 10, a disk drive for reading from or writing to a removable, non-volatile magnetic disk (e.g., a “soft disk”) and an optical disk drive for reading from or writing to a removable, non-volatile optical disk may be provided. In these cases, each drive may be connected to a bus (not shown) by one or more data medium interfaces. The memory 1020 may include a computer program product 1025 having one or more program modules configured to perform various methods or actions of various embodiments of the present disclosure.

The communication unit 1040 implements communication with another electronic device through a communication medium. Additionally, the functions of components of the electronic device 1000 may be implemented in a single computing cluster or multiple computing machines capable of communicating over a communication connection. Thus, the electronic device 1000 may operate in a networked environment using logical connections with one or more other servers, network personal computers (PCs), or another network node.

The input device 1050 may be one or more input devices such as mouse, keyboard, trackball, or the like. The output device 1060 may be one or more output devices, such as display, speaker, printer, or the like. The electronic device 1000 may also communicate with one or more external devices (not shown) such as storage device, display device, etc. through the communication unit 1040 as needed, communicate with one or more devices that enable a user to interact with the electronic device 1000, or communicate with any device (e.g., a network card, a modem, etc.) that enables the electronic device 1000 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Various aspects of the present disclosure are described herein with reference to flowchart(s) and/or block diagram(s) of methods, apparatuses, devices, and computer program products implemented in accordance with the present disclosure. It should be understood that each of the block(s) of the flowchart(s) and/or block diagram(s) and combination(s) of respective blocks in the flowchart(s) and/or block diagram(s) may be implemented by computer-readable program instructions.

These computer-readable program instructions may be provided to a processing unit of a general purpose computer, a special purpose computer, or another programmable data processing apparatus to produce a machine, such that the instructions, when executed by a processing unit of a computer or another programmable data processing apparatus, produce means to implement the functions/actions specified in one or more blocks of the flowchart(s) and/or block diagram(s). These computer-readable program instructions, which cause the computer, the programmable data processing apparatus and/or the other device to operate in a particular manner, may also be stored in a computer-readable storage medium, such that the computer-readable medium storing instructions includes a manufactured article including instructions to implement various aspects of the functions/actions specified in one or more blocks of the flowchart(s) and/or block diagram(s).

The computer-readable program instructions may be loaded onto a computer, another programmable data processing apparatus, or another device, such that a series of operational steps are performed on the computer, the other programmable data processing apparatus, or the other device to produce a computer-implemented process, thereby enabling the instructions executed on the computer, the other programmable data processing apparatus, or the other device to implement the functions/actions specified in one or more blocks of the flowchart(s) and/or block diagram(s).

The flowchart(s) and block diagram(s) in the drawings show architecture(s), function(s), and operation(s) possibly implemented by system(s), method(s), and computer program product(s) according to multiple implementations of the present disclosure. In this regard, each block in the flowchart(s) or block diagram(s) may represent a module, a program segment, or a portion of instructions that includes one or more executable instructions for implementing specified logic function. In some alternative implementations, the functions noted in the blocks may also occur in a different order from that noted in the drawings. For example, two consecutive blocks may actually be performed substantially in parallel, or may sometimes be performed in a reverse order, depending on the functions involved. It is also noted that each block in the block diagram(s) and/or flowchart(s) as well as combination(s) of blocks in the block diagram(s) and/or flowchart(s) may be implemented with a dedicated hardware-based system that performs specified functions or actions, or may be implemented with a combination of dedicated hardware and computer instructions.

Various implementations of the present disclosure have been described above, which are example and not exhaustive, and the implementations disclosed are not limiting. Many modifications and variations will be apparent to those ordinary skilled in the art without departing from the scope and spirit of the various implementations illustrated. The selection of the terms used herein is intended to best explain the principles, practical applications, or improvements to techniques in the marketplace of respective implementations, or to enable other ordinary skilled in the art to understand respective implementations disclosed herein.

1-14. (canceled)

15. A method for question answering, comprising:
in response to detecting a question answering initiation, capturing image data and speech data using a device of a user, the speech data indicating an intent related to a question;
determining an answer corresponding to the question from the image data according to the intent; and
outputting the answer at least in form of speech.

16. The method of claim 15, further comprising:
presenting a recording interface, the recording interface comprising at least a recording control; and
detecting the question answering initiation by detecting a predetermined operation on the recording control.

17. The method of claim 15, wherein capturing image data comprises:
selecting, from a captured image dataset, the image data with a visual quality exceeding a quality threshold.

18. The method of claim 15, wherein capturing image data comprises:
determining whether a predetermined visual quality problem occurs in the captured image data; and
in accordance with a determination that the predetermined visual quality problem occurs, prompting the user to adjust a capturing environment to recapture the image data.

19. The method of claim 18, wherein the predetermined visual quality problem comprises at least an underexposure problem or an overexposure problem.

20. The method of claim 15, wherein capturing image data comprises:
during the capturing, prompting to the user description information on the image data captured by the device; and
obtaining the image data captured by the device in response to detecting a capturing confirmation.

21. The method of claim 20, wherein the description information indicates at least one of the following: at least one object presented in the image data, or a relative positional relationship between the at least one object.

22. The method of claim 20, wherein prompting the description information indicates:
in response to detecting a target exploring operation, prompting the description information.

23. The method of claim 15, wherein the answer is determined using a trained question answering model, and a model input of the question answering model comprises the image data and a text sequence corresponding to the speech data.

24. The method of claim 23, wherein the question answering model at least comprises a cross attention module, and the question answering model is configured to determine the answer by:
extracting an image feature of the image data;
extracting a semantic feature of the text sequence;
generating an aggregated feature by providing the semantic feature as a query input of the cross attention module and providing the image feature as a key input and a value input of the cross attention module; and
determining the answer based on the aggregated feature.

25. The method of claim 23, wherein the question answering model corresponds to a first question answering scenario of a plurality of question answering scenarios, and the question answering model is selected based on the image data and the speech data being classified into the first question answering scenario.

26. An electronic device, comprising:
at least one processor; and
at least one memory coupled to the at least one processor and storing instructions executable by the at least one processor, the instructions, when executed by the at least one processor, causing the electronic device to perform operations comprising:
in response to detecting a question answering initiation, capturing image data and speech data using a device of a user, the speech data indicating an intent related to a question;
determining an answer corresponding to the question from the image data according to the intent; and
outputting the answer at least in form of speech.

27. The electronic device of claim 26, wherein the operations further comprise:
presenting a recording interface, the recording interface comprising at least a recording control; and
detecting the question answering initiation by detecting a predetermined operation on the recording control.

28. The electronic device of claim 26, wherein capturing image data comprises:
selecting, from a captured image dataset, the image data with a visual quality exceeding a quality threshold.

29. The electronic device of claim 26, wherein capturing image data comprises:
determining whether a predetermined visual quality problem occurs in the captured image data; and
in accordance with a determination that the predetermined visual quality problem occurs, prompting the user to adjust a capturing environment to recapture the image data,
wherein the predetermined visual quality problem comprises at least an underexposure problem or an overexposure problem.

30. The electronic device of claim 26, wherein capturing image data comprises:
during the capturing, prompting to the user description information on the image data captured by the device; and
obtaining the image data captured by the device in response to detecting a capturing confirmation,
wherein the description information indicates at least one of the following: at least one object presented in the image data, or a relative positional relationship between the at least one object.

31. The electronic device of claim 30, wherein prompting the description information indicates:
in response to detecting a target exploring operation, prompting the description information.

32. The electronic device of claim 26, wherein the answer is determined using a trained question answering model, and a model input of the question answering model comprises the image data and a text sequence corresponding to the speech data.

33. The electronic device of claim 32, wherein the question answering model at least comprises a cross attention module, and the question answering model is configured to determine the answer by:
extracting an image feature of the image data;
extracting a semantic feature of the text sequence;
generating an aggregated feature by providing the semantic feature as a query input of the cross attention module and providing the image feature as a key input and a value input of the cross attention module; and
determining the answer based on the aggregated feature.

34. A non-transitory computer-readable storage medium having a computer program stored thereon which, when executed by a processor, perform operations comprising:
in response to detecting a question answering initiation, capturing image data and speech data using a device of a user, the speech data indicating an intent related to a question;
determining an answer corresponding to the question from the image data according to the intent; and
outputting the answer at least in form of speech.
